(19) United States
(12) Patent Application Publication
(10) Pub. No.: US 2023/0324702 A1
(43) Pub. Date: Oct. 12, 2023

(54) DEVICE FOR AUGMENTING A VIRTUAL REALITY EXPERIENCE

(71) Applicants: Sourabh Jain, San Francisco, CA (US); Andreea Hamill, Antioch, CA (US)

(72) Inventors: Sourabh Jain, San Francisco, CA (US); Andreea Hamill, Antioch, CA (US)

(21) Appl. No.: 18/195,580

(22) Filed: May 10, 2023

Related U.S. Application Data
(63) Continuation of application No. 63/329,669, filed on Apr. 11, 2022.

(51) Int. Cl. G02B 27/01

(52) U.S. Cl. CPC G02B 27/0176

(57) ABSTRACT

In an embodiment of the disclosed principles, a device and method are provided for augmenting a virtual reality experience. The invention includes an absorbent pad configured to absorb a fragrant liquid and a housing configured to hold the absorbent pad within, while allowing fragrance of the pad to permeate through or escape out of the housing. A coupling mechanism is further provided for detachably coupling the housing to an exterior surface of a virtual reality (VR) headset.

### RELATED APPLICATION

The present application is related to like-titled U.S. Application Ser. No. 63/329,669, and claims priority thereto. Moreover, the prior application, referenced above, is herein incorporated by reference in its entirety for all that it teaches, discloses or suggests, without exclusion of any portion thereof.

### TECHNICAL FIELD

The present invention relates generally to a device and method for augmenting a virtual reality experience, and more specifically to a detachable device for holding a fragrant item in association with a VR headset, and method associated therewith.

### BACKGROUND

Virtual reality headsets have become increasingly popular, accessible, and affordable in recent years, and many households now have one or more such headsets. Users enjoy them partly because they provide a more immersive experience than other games consoles and devices; however there are no currently available solutions with an integrated olfactory element. Providing fragrant smells to accompany the virtual experiences enjoyed by users on these headsets is thus one area where the immersion factor could be increased.

One method of doing so is to hold a fragrant material to a user's nose while they use the headset, and some accessories have been designed to do just that—however the available technologies for doing so are often complex, costly, bulky, heavy, and difficult to maintain or only work with synthetic fragrances.

There is a need for a device that is simple and compact in design and which can be used to enhance a user's virtual reality experience by providing a fragrance to accompany what the user is seeing. The device must also facilitate easy switching between different fragrances. It is within this context that the present invention is provided.

However, before proceeding, it should be appreciated that while the present disclosure is directed to a system that may address some of the shortcomings listed or implicit in this Background section, any such benefit is not a limitation on the scope of the disclosed principles, or of the attached claims, except to the extent expressly noted in the claims.

Additionally, the discussion of technology in this Background section is reflective of the inventors' own observations, considerations, and thoughts, and is in no way intended to accurately catalog or comprehensively summarize any prior art reference or practice. As such, the inventors expressly disclaim this section as admitted or assumed prior art. Moreover, the identification herein of one or more desirable courses of action reflects the inventors' own observations and ideas, and should not be assumed to indicate an art-recognized desirability.

### SUMMARY

The present disclosure provides a device and method for enhancing a virtual reality experience for a user, providing an olfactory element to the experience by holding an absorbent piece of material infused with a fragrant liquid close to a user's nose by mounting it on an exterior surface of the virtual reality headset being used. In this way, any fragrant liquid can be used, and the fragrance can be easily swapped out for other fragrances by having the housing of the device configured to trap and release the absorbent material.

Thus, according to one aspect of the present disclosure there is provided a device for augmenting a virtual reality experience, the device comprising an absorbent pad configured to absorb a fragrant liquid, a housing configured to hold the absorbent pad within while allowing fragrance of the pad to permeate through or escape out of the housing, and a coupling mechanism for detachably coupling the housing to an exterior surface of a virtual reality headset.

While cotton felt is mentioned as an ideal pad material, other absorbent materials such as wool, nylon, microfiber, felt or any combination of thereof may instead be used.

In some embodiments, the housing is in the form of a locket having first and second sections coupled by a hinge and comprises a latch mechanism for holding the locket closed. In other embodiments, the housing is in the form of a clip having first and second sections held together by a spring-like bearing. The material forming the housing may be any suitable material, e.g., wood, plastic, metal, metal alloy, cork, leather or any combination thereof.

In some embodiments, the coupling mechanism comprises a first Velcro piece attached to the housing and a corresponding second Velcro piece having a flat rear surface coated in adhesive for mounting it to the exterior surface of a VR headset. However, it will be appreciated that many other attachment mechanisms are suitable alternatives, including buttons, snaps, laces, hook-and-eye fasteners, buckles, twist-ties, magnets, slide-flat hooks, safety pins, rubber bands, adhesive, tape or any combinations thereof. Such attachment mechanisms may be permanent, semi-permanent, or easily removable.

In some embodiments, an exterior surface of the housing is provided with an aesthetic design, shape, or engraving.

Other features and aspects of the disclosed principles will be apparent from the detailed description taken in conjunction with the included figures.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 illustrates an exploded components view of an example configuration of a device according to the present disclosure.

FIG. 2 illustrates an isometric view of the example configuration of the device in an assembled state.

FIG. 3 illustrates a first isometric view of an adhesive/Velcro patch installed on the exterior side of a virtual reality headset for mounting the device.

FIG. 4 illustrates a first isometric view of the example configuration of the device installed on the side of the headset.

FIG. 5 illustrates a second isometric view of two adhesive/Velcro patches installed on the underside of a virtual reality headset for mounting the device.

FIG. 6 illustrates a second isometric view of two example devices installed on the underside of the headset.

Common reference numerals are used throughout the figures and the detailed description to indicate like elements. One skilled in the art will readily recognize that the figures herein are examples and that other architectures, modes of operation, orders of operation, and elements/functions can be provided and implemented without departing from the characteristics and features of the invention, as set forth in the claims.

### DETAILED DESCRIPTION

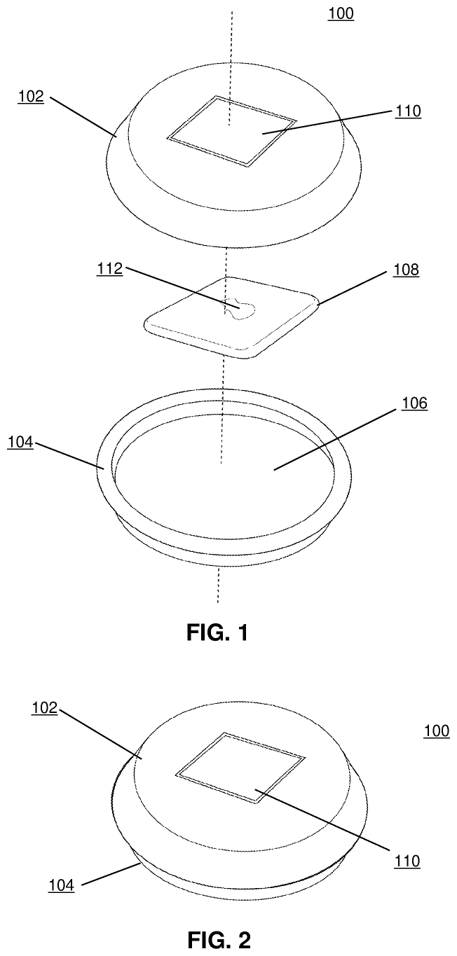

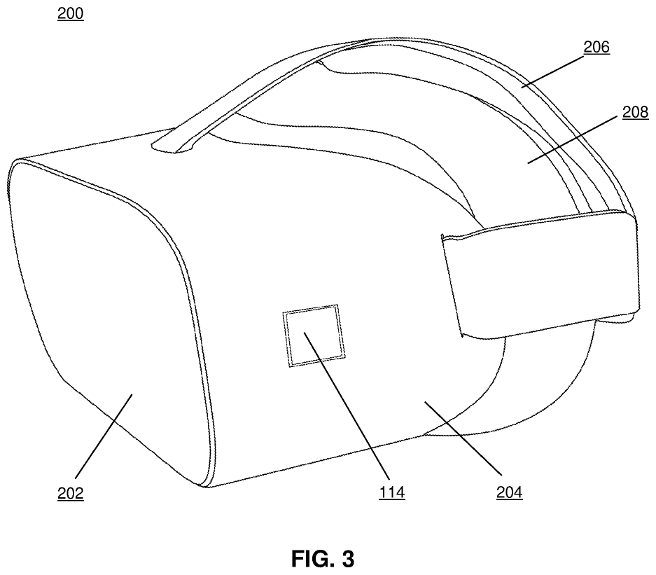

We turn now to a more detailed discussion of the disclosed principles in conjunction with the attached figures. Referring to FIG. 1, an exploded components view of an example configuration of a device 100 according to the present disclosure is shown. The device of FIG. 1 is then shown in an assembled state in FIG. 2.

The example device 100 in the illustrated embodiment includes a locket-shaped housing having a first section 102 and a second section 104 that are secured to one another by a hinge or otherwise, allowing the housing to open and close about an interior volume 106. In some embodiments, the housing includes a latch mechanism for holding the locket closed. In other embodiments, the housing is in the form of a clip having first and second sections held together by a spring-like bearing. The material forming the housing may be any suitable material, e.g., wood, plastic, metal, metal alloy, cork, leather or any combination thereof.

The device 100 as shown further comprises an absorbent element 108, which in the present example is a pad of cotton felt, onto which fragrant liquids such as essential oils can be deposited and absorbed. A patch of absorbed liquid 112 can be seen on the pad 108. While cotton is mentioned as an ideal pad material, other absorbent materials such as wool, nylon, microfiber, felt or any combination of thereof may instead be used.

The device further comprises a coupling mechanism, such as but not limited to a Velcro patch 110, attached to the exterior of the housing 100 and a corresponding second Velcro piece having a flat rear surface coated in adhesive for mounting it to the exterior surface of a VR headset. However, it will be appreciated that many other attachment mechanisms are suitable alternatives, including buttons, snaps, laces, hook-and-eye fasteners, buckles, twist-ties, magnets, slide-flat hooks, safety pins, rubber bands, adhesive, tape or any combinations thereof. Such attachment mechanisms may be permanent, semi-permanent, or easily removable.

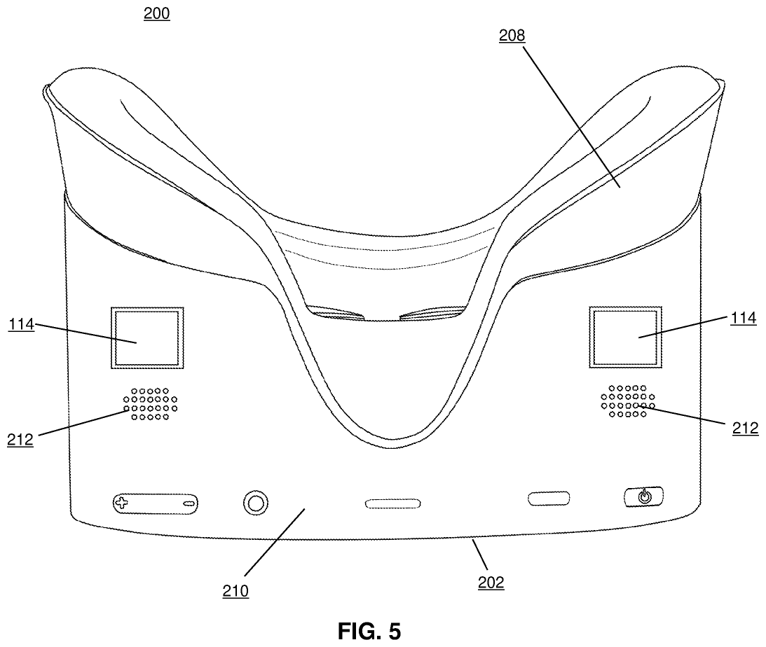

Continuing on with reference to FIGS. 3 and 5, the Velcro patch 110 will allow the device 100 to be detachably mounted to a mating patch 114, which is mounted to an exterior surface of the VR headset 200, e.g., by adhesive. Other coupling methods may also be used.

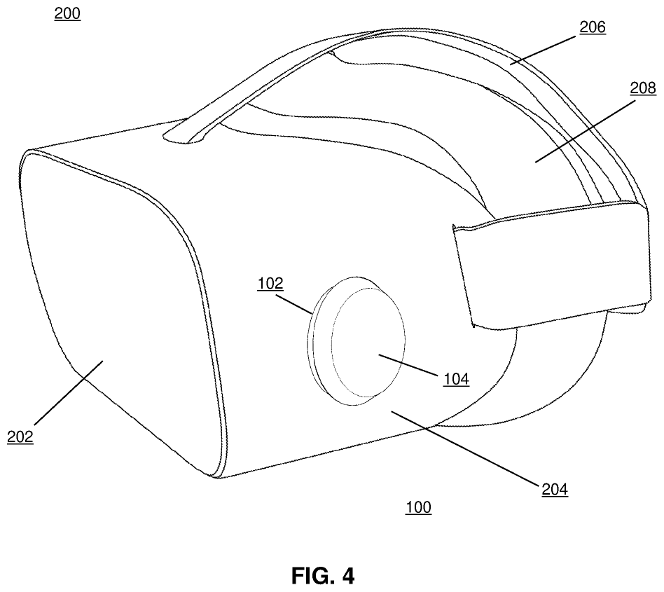

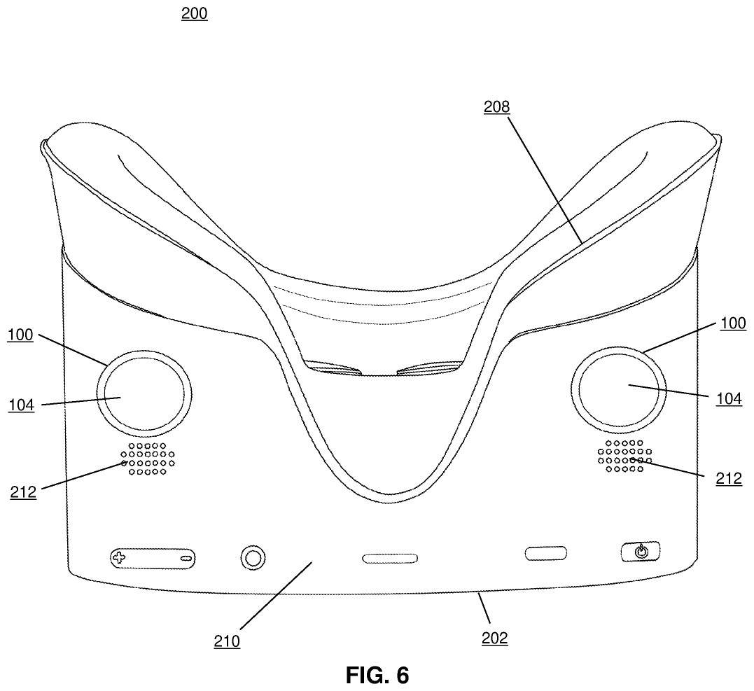

As can be seen in FIGS. 3-6, the patches 114 and thus the devices 100 can be mounted at various points about the headset 200, including the side surfaces 204, and the bottom surface 210 of the main housing—for example near the speakers 212 close to where the user's nose is positioned during use. Preferably, the devices should not be mounted on the straps 206 of the headset 200, since this would position the fragrance too far from the user's nose.

While the present example is in the form of a locket that can be detachably mounted to the exterior surface of a VR headset 200, other shapes of housing can also be used as long as they allow an absorbent pad to be mounted to the headset.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the device have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “such that,” and “operable to” do not imply any particular tangible or intangible modification of a subject, but, rather, are intended to be used interchangeably. A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as an “aspect” may refer to one or more aspects and vice versa. A phrase such as an “embodiment” does not imply that such embodiment is essential to the subject technology or that such embodiment applies to all configurations of the subject technology.

A disclosure relating to an embodiment may apply to all embodiments, or one or more embodiments. An embodiment may provide one or more examples of the disclosure. A phrase such an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as a “configuration” may refer to one or more configurations and vice versa.

The words “exemplary,” “exemplify,” and “example” are used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

Reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub combination or variation of a sub combination.

It will be appreciated that various systems and processes have been disclosed herein. However, in view of the many possible embodiments to which the principles of the present disclosure may be applied, it should be recognized that the embodiments described herein with are meant to be illustrative only and should not be taken as limiting the scope of the claims. Therefore, the techniques as described herein contemplate all such embodiments as may come within the scope of the following claims and equivalents thereof.

We claim:

1. A device for augmenting a virtual reality experience, the device comprising:
an absorbent pad configured to absorb a fragrant liquid;
a housing configured to hold the absorbent pad within while allowing fragrance of the pad to permeate through or escape out of the housing; and
a coupling mechanism for coupling the housing to an exterior surface of a virtual reality (VR) headset, wherein the coupling mechanism is one of permanent, semi-permanent, and removable.

2. The device in accordance with claim 1, wherein the housing is in the form of a locket having first and second sections coupled by a hinge, the housing further comprising a latch mechanism for holding the locket closed.

3. The device in accordance with claim 2, wherein the housing comprises one or more of wood, plastic, metal, metal alloy, cork and leather.

4. The device in accordance with claim 1, wherein the housing is in the form of a clip having first and second sections held together by a spring-like bearing.

5. The device in accordance with claim 1, wherein the coupling mechanism comprises a first Velcro piece attached to the housing and a corresponding second Velcro piece having a flat rear surface coated in adhesive for mounting it to the exterior surface of the VR headset.

6. The device in accordance with claim 1, wherein the coupling mechanism comprises one or more of buttons, snaps, laces, hook-and-eye fasteners, buckles, twist-ties, magnets, slide-flat hooks, safety pins, rubber bands, adhesive and tape.

7. The device in accordance with claim 1, wherein an exterior surface of the housing is provided with an aesthetic design, shape, or engraving.

8. The device in accordance with claim 1, wherein the absorbent pad comprises a piece of cotton felt.

9. The device in accordance with claim 1, wherein the absorbent pad comprises one or more of wool, nylon, microfiber and felt.

10. A method for augmenting a virtual reality experience, the method comprising:
placing an absorbent pad configured to absorb a fragrant liquid, and having absorbed said fragrant liquid, into a housing configured to hold the absorbent pad within while allowing fragrance of the pad to permeate through or escape out of the housing, and permanently, semi-permanently, or removably coupling the housing to an exterior surface of a virtual reality (VR) headset.

11. The method in accordance with claim 10, wherein the housing is in the form of a locket having first and second sections coupled by a hinge, the housing further comprising a latch mechanism for holding the locket closed, and wherein placing the absorbent pad into the housing comprises placing the absorbant pad into the open housing and then closing the housing.

12. The method in accordance with claim 11, wherein the housing comprises one or more of wood, plastic, metal, metal alloy, cork and leather.

13. The method in accordance with claim 10, wherein the housing is in the form of a clip having first and second sections held together by a spring-like bearing.

14. The method in accordance with claim 10, wherein the coupling mechanism comprises a first Velcro piece attached to the housing and a corresponding second Velcro piece having a flat rear surface coated in adhesive for mounting it to the exterior surface of the VR headset, and wherein coupling the housing to an exterior surface of a virtual reality (VR) headset comprises placing the first Velcro piece into contact with the second Velcro piece.

15. The method in accordance with claim 10, wherein the coupling mechanism comprises one or more of buttons, snaps, laces, hook-and-eye fasteners, buckles, twist-ties, magnets, slide-flat hooks, safety pins, rubber bands, adhesive and tape.

16. The method in accordance with claim 10, further comprising providing an exterior surface of the housing with an aesthetic design, shape, or engraving.

17. The method in accordance with claim 10, wherein the absorbent pad comprises a piece of cotton felt.

18. The method in accordance with claim 10, wherein the absorbent pad comprises one or more of wool, nylon, microfiber and felt.
